(19) United States
(12) Patent Application Publication
(10) Pub. No.: US 2011/0149507 A1
(43) Pub. Date: Jun. 23, 2011

(54) COMPUTER SYSTEM

(75) Inventors: JIAN-MIN WU, Shenzhen City (CN); ZHAN-YANG LI, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/840,191

(22) Filed: Jul. 20, 2010

(30) Foreign Application Priority Data
Dec. 23, 2009 (CN) 200920318207.8

(51) Int. Cl. G06F 1/20

(52) U.S. Cl. 361/679.48

(57) ABSTRACT

A computer system includes a chassis, a fan bracket and an air duct. The fan bracket is configured for receiving a fan and secured in the chassis. A retaining flange is located on the fan bracket. The air duct is secured in the chassis and includes a top portion and two side portions connected to the top portion. A locking block is located between the two side portions and defines a slit that receives the retaining flange. The air duct directs airflow through the fan bracket.

### BACKGROUND

1. Technical Field

The present disclosure relates to a computer system with an air duct for directing airflow.

2. Description of Related Art

A plurality of fans is used in a computer system for cooling electronic elements. But in order to improve cooling efficiency, an air duct for directing airflow is often needed.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a partly exploded view of a computer system in accordance with an embodiment.

FIG. 2 is an isometric view of an air duct of the computer system of FIG. 1.

FIG. 3 is an assembled view of the computer system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

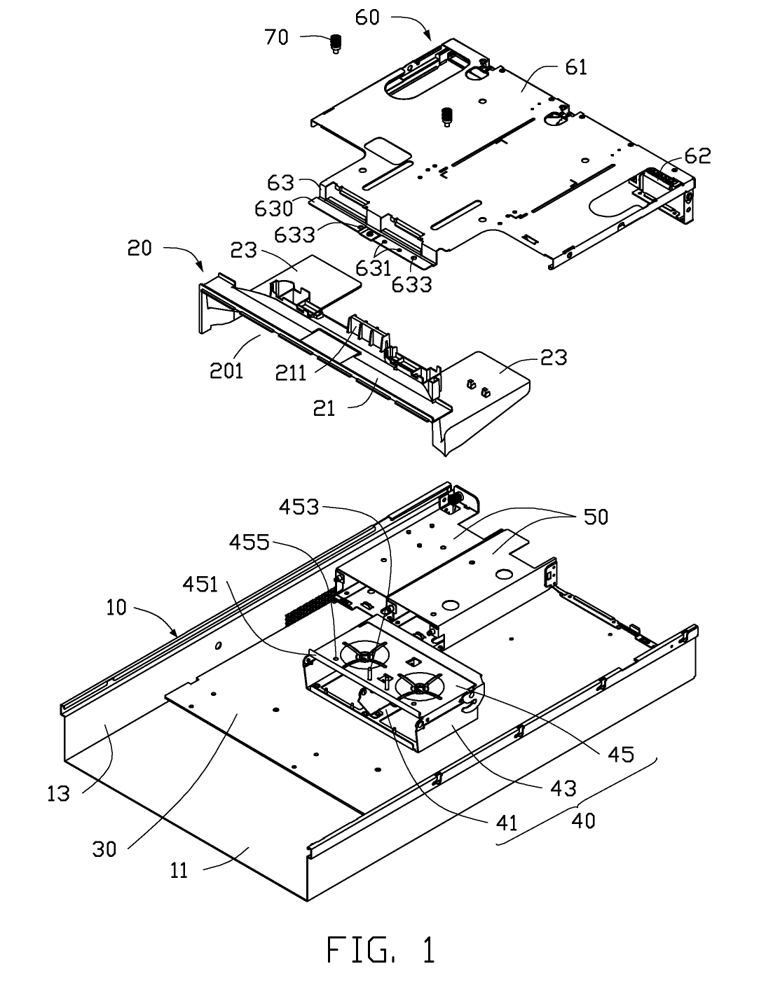

Referring to FIG. 1, a computer system in accordance with an embodiment includes a chassis 10, a top cover 60, and an air duct 20.

The chassis 10 includes a bottom plate 11 and two opposite side plates 13 connected to the bottom plate 11. A circuit board 30 is secured to the bottom plate 11 between the side plates 13. In an embodiment, the side plates 13 are substantially parallel to each other and substantially perpendicular to the bottom plate 11, and the circuit board 30 is a motherboard. The fan bracket 40 is configured for securing fans (not shown) and secured to the circuit board 30. The fans are used to cool electronic element (not shown) positioned in the fan bracket 40. The fan bracket 40 includes a bottom wall 41, top wall 45, and two opposite sidewalls 43. The sidewalls 43 are connected to the bottom wall 41 and the top wall 45. In an embodiment, the top wall 45 is substantially parallel to the bottom wall 41, and the sidewalls 43 are substantially parallel to each other and substantially perpendicular to the bottom wall 41. Two positioning posts 453 are located on the top wall 45, and two securing holes 455 are defined in the top wall 45. A retaining flange 451 is located on a rear edge of the top wall 45. Two drive brackets 50 are located above the circuit board 30 between the side plates 13, for securing disk drives, such as hard disk drives.

The top cover 60 is configured to be secured to the chassis 10 and includes a cover body 61, a front portion 62, and a rear portion 63 opposite to the front portion 62. A supporting flange 630 is located on the rear portion 63. Two through holes 633 are defined in the supporting flange 630, corresponding to the two securing holes 455, and two mounting holes 631 are defined in the supporting flange 630, corresponding to the two positioning posts 453.

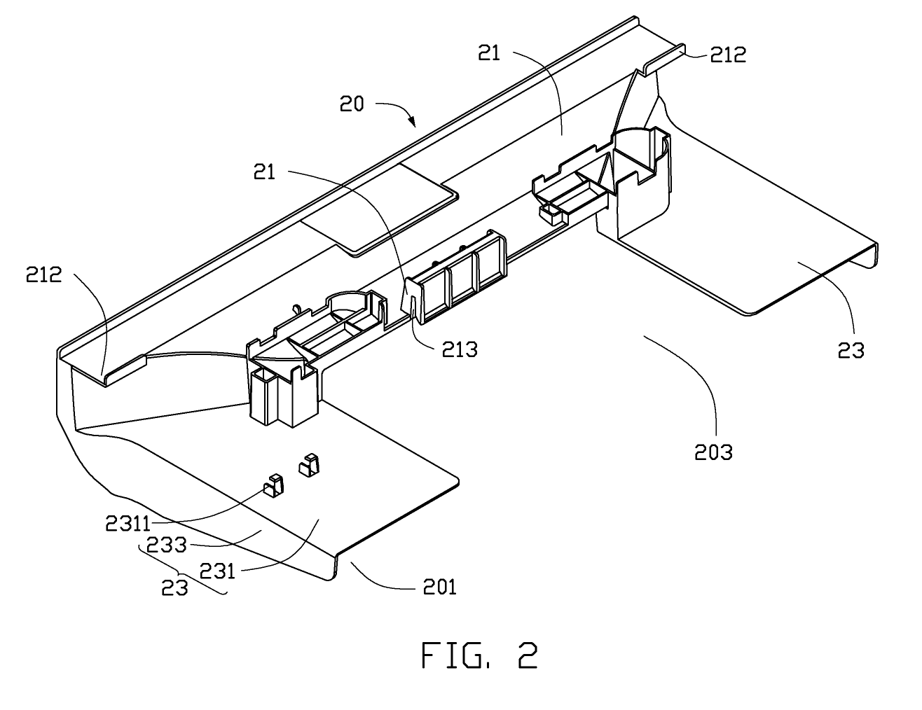

Referring to FIGS. 1-2, the air duct 20 includes a top portion 21 and two side portions 23. The top portion 21 and the side portions 23 cooperate to define an air channel 201. A cutout 203 is defined in the air duct 20 between the side portions 23. A locking block 211 is located on an edge of the top portion 21 adjacent the cutout 203. A slit 213 is defined in the locking block 211, for receiving the retaining flange 451 of the fan bracket 40. Two extending pieces 212 extend from the top portion 21, respectively above the side portions 23. Each side portion 23 includes a top panel 231 and a side panel 233 connected to the top panel 231. In an embodiment, the side panel 233 is substantially perpendicular to the top panel 231. Two cable managers 2311 are located on the top panel 231 of one side portion 23.

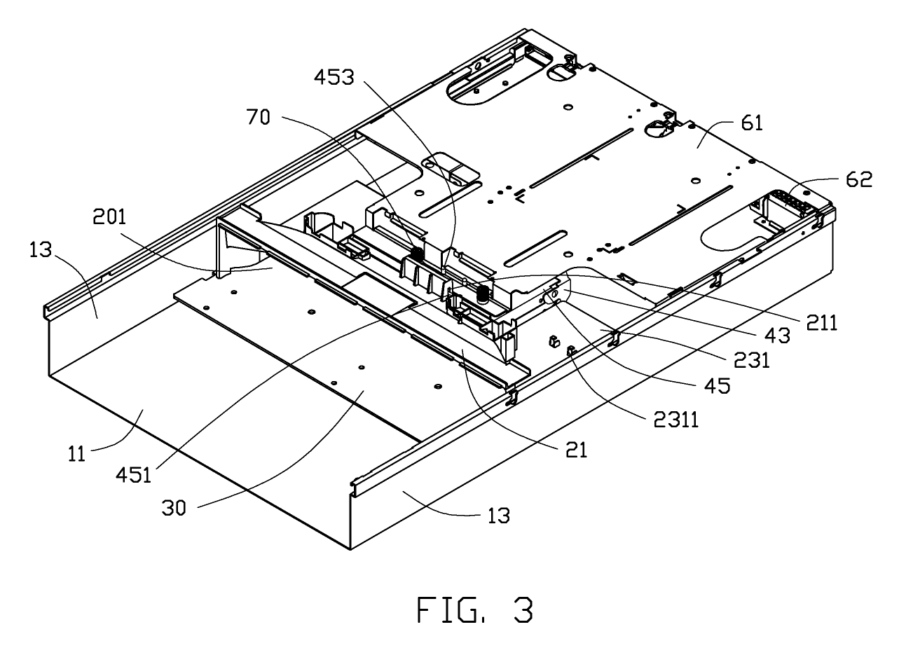

Referring to FIGS. 1-3, the top cover 60 is secured to the chassis 10 above the drive brackets 50 and the fan bracket 40. The front portion 62 is positioned between the drive brackets 50 and one side plate 13. The rear portion 63 is supported on the fan bracket 40. The positioning posts 453 are inserted into the mounting holes 631 of the top cover 60. The through holes 633 of the top cover 60 align with the securing holes 455 of the fan bracket 40. Two fasteners 70 are threaded in the through holes 633 and the securing holes 455, to secure the top cover 60 on the fan bracket 40. The air duct 20 is placed in the chassis 10. The fan bracket 40 is positioned between the side portions 23. The retaining flange 451 is received into the slit 213 of the air duct 20.

In use, airflow can be guided by the air channel 201 of the air duct 20 to be concentrated to pass through the fan bracket 40, to quickly remove heat generated from electronic elements positioned in the fan bracket 40.

In disassembly, because the air duct 20 is positioned on the fan bracket 40 with engagement between the slit 213 and the retaining flange 451, the air duct 20 is very easily removed from the chassis 10.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A computer system comprising:
a chassis;
a fan bracket configured for receiving a fan, the fan bracket secured in the chassis, a retaining flange being located on the fan bracket; and
an air duct, secured in the chassis, comprises a top portion and two side portions connected to the top portion; a locking block is located between the two side portions, and the locking block defines a slit that receives the retaining flange;
wherein the air duct directs airflow through the fan bracket.

2. The computer system of claim 1, wherein a circuit board is secured in the chassis; and the fan bracket is secured to the circuit board.

3. The computer system of claim 1, wherein the air duct defines a cutout between the two side portions; and the fan bracket is positioned in the cutout.

4. The computer system of claim 1, wherein the locking block is located on the top portion of the air duct; and the slit is defined in the locking block.

5. The computer system of claim 1, wherein the top portion abuts the fan bracket.

6. The computer system of claim 1, wherein a cable manager is located on one of the two side portions for managing cable.

7. The computer system of claim 1, further comprising a top cover secured to the chassis and the fan bracket.

8. The computer system of claim 7, wherein the top cover defines a mounting hole; and a positioning post is located on the fan bracket and engaged in the mounting hole.

9. The computer system of claim 7, further comprising a drive bracket configured for receiving disk drive, and the fan bracket and the drive bracket are covered by the top cover.

10. A computer system comprising:
a chassis comprising a bottom plate and two opposite side plates connected to the bottom plate;
a circuit board secured to the bottom plate between the two opposite side plates;
a fan bracket configured for receiving a fan, and the fan bracket is secured to the circuit board;
a drive bracket secured in the chassis above the circuit board;
an air duct secured to the fan bracket; and
a top cover secured to the two opposite side plates and the fan bracket;
wherein the top cover and the two opposite side plates cover the fan bracket and the drive bracket, and the air duct directs airflow through the fan bracket.

11. The computer system of claim 10, wherein the air duct comprises a top portion and two side portions connected to the top portion and defines a cutout between the two side portions; and the fan bracket is positioned in the cutout.

12. The computer system of claim 11, wherein a retaining flange is located on the fan bracket; a locking block is located on the top portion of the air duct; and the locking block defines a slit that receives the retaining flange.

13. The computer system of claim 11, wherein the top portion abuts the fan bracket.

14. The computer system of claim 11, wherein a cable manager is located on one of the two side portions for managing cable.

15. The computer system of claim 10, wherein the top cover defines a mounting hole; and a positioning post is located on the fan bracket and engaged in the mounting hole.
